(19) United States
(12) Patent Application Publication
(10) Pub. No.: US 2006/0218843 A1
(43) Pub. Date: Oct. 5, 2006

(54) Sensing alarm

(76) Inventors: Frank V. Sanchez, Gallup, NM (US); Frank S. Sanchez, Gallup, NM (US)

Correspondence Address: Kevin Lynn Wildenstein;Southwest Intellectual Property Services, LLC, Suite 8, 6700-B Jefferson, Albuquerque, NM, 87109, US

(21) Appl. No.: 11/393,313

(22) Filed: Mar. 30, 2006

Related U.S. Application Data
(60) Provisional application No. 60/667,660, filed on Apr. 1, 2005.

(51) Int. Cl. A01K 97/12

(52) U.S. Cl. 43/17

(57) ABSTRACT

The present invention is a sensing alarm adapted to provide both (or either) visual and audible alarms to the operator upon the occurrence of an event. In one embodiment, the present invention includes a housing adapted to retain and store control electronics, an indicator on housing which is in electronic communication with the control electronics through a switch, a receiving bracket and a reciprocal contact bracket, at least both members being securely attached to a top portion of the housing and both members being in electrical communication with the control electronics so that when compression occurs between the brackets, an alarm event occurs. In another embodiment, the control electronics may further include a microprocessor in electrical communication with the switch, the microprocessor being adapted to transmit information with a remotely located computer.

### CLAIM OF PRIORITY

The present invention claims priority based upon U.S. Provisional Patent Application No. 60/667,660, filed Apr. 1, 2005, which is hereby incorporated by reference.

### FIELD OF INVENTION

The present invention relates generally to a sensing alarm or sensing apparatus adapted for use in various circumstances to notify an operator of an event occurring including security, and in particular, to a aid in the fishing arts that allows the fisherman to do other tasks while fishing without the need to worry about missing a fish strike.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention is a sensing alarm adapted to provide both (or either) visual and audible alarms to the operator upon the occurrence of an event. In one embodiment, the present invention includes a housing adapted to retain and store control electronics, an indicator on housing which is in electronic communication with the control electronics, a receiving bracket and a reciprocal contact bracket, at least both members being securely attached to a top portion of the housing and both members being in electrical communication with the control electronics so that when compression occurs between the brackets, an alarm event occurs.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1a is a side perspective view of one aspect of the present invention;

FIG. 1b is another side perspective view of FIG. 1a, illustrating one representative operation of the present invention; and

FIG. 2 is a block diagram primarily illustrating the control electronics of the present invention.

Additional aspects of the present invention will become evident upon reviewing the non-limiting embodiments described in the specification and the claims taken in conjunction with the accompanying figures, wherein like reference characters denote like elements.

### DETAILED DESCRIPTION OF THE PREFERRED EMBODIMENT

Preferred embodiments of the present invention will hereafter be described in detail with reference to the accompanying drawings.

The present invention is a sensing alarm adapted to generate both (or either) visual and audible alarms to the operator upon the occurrence of an event. In the preferred embodiment of the present invention, the sensing apparatus is adapted to assist a fisherman, who may be multitasking nearby or remotely, to be notified of when a fish bites or strikes a fishing line attached to a fishing rod or like device.

The present invention includes a housing 10 adapted to retain and store control electronics 40, an indicator 50 on housing 10 which is in electronic communication with the control electronics 40, a generally L shaped receiving bracket or member 20 and a generally L shaped reciprocal contact bracket member 30, at least both members being securely attached to a top portion of the housing 10 and both members being in electrical communication with the control electronics 40.

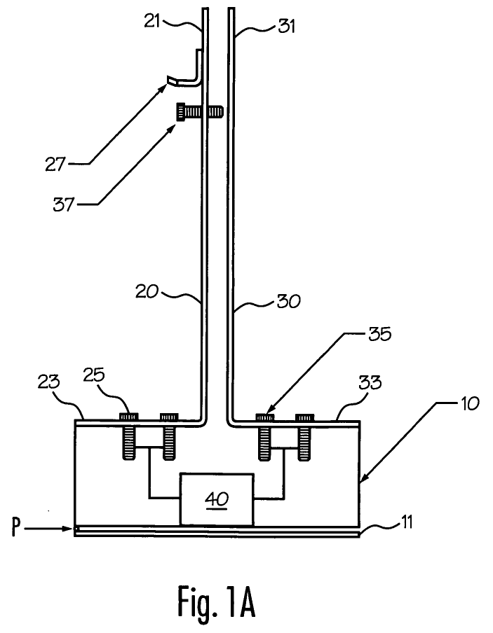

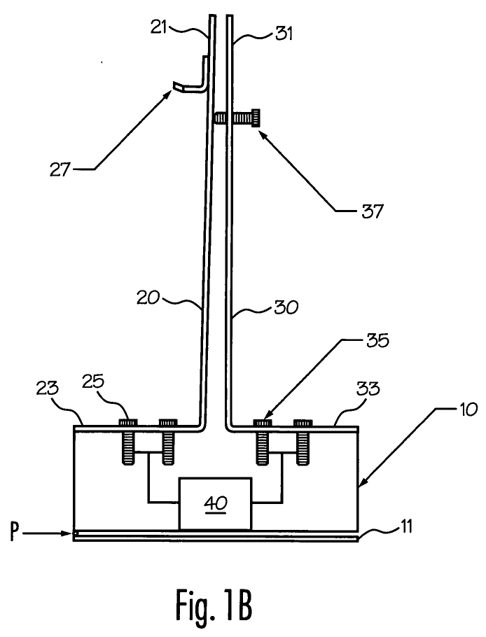

Housing 10, in one embodiment, may be formed of suitable material which can withstand environmental extremes (such as high humidity, heat, or sold weather), yet protect the control electronics residing 40 therein. Thus, one suitable material may include plastic, with the interior of housing 10 being sealed appropriately (such as, for example, being hermetically sealed). While the illustrations provided in this invention show that the housing is generally rectangular in nature, those of skill in the art will realize that other shapes are available which remain within the spirit and scope of the present invention. Of course, while not shown in the illustrations, housing 10 may also be designed to have one or more prominent visible surfaces to allow manufacturing logos or advertisements to be placed thereon. Further, as seen in FIG. 1, housing 10 may preferably include a mounting plate or stability platform 11 rotatably attached to a bottom surface of housing 10 through pivot point P. In one embodiment, as seen in FIG. 1, the mounting plate 11 has a substantially similar surface area as the housing's bottom surface. Mounting plate 11 is preferably adapted to provide the present invention with structural integrity and also provides structural stability when the present invention is in use during adverse conditions (such as may occur during particularly windy weather, or, when a fish bite is particularly strong enough to jerk the fishing rod line end violently, to thus cause potential imbalance of the present invention).

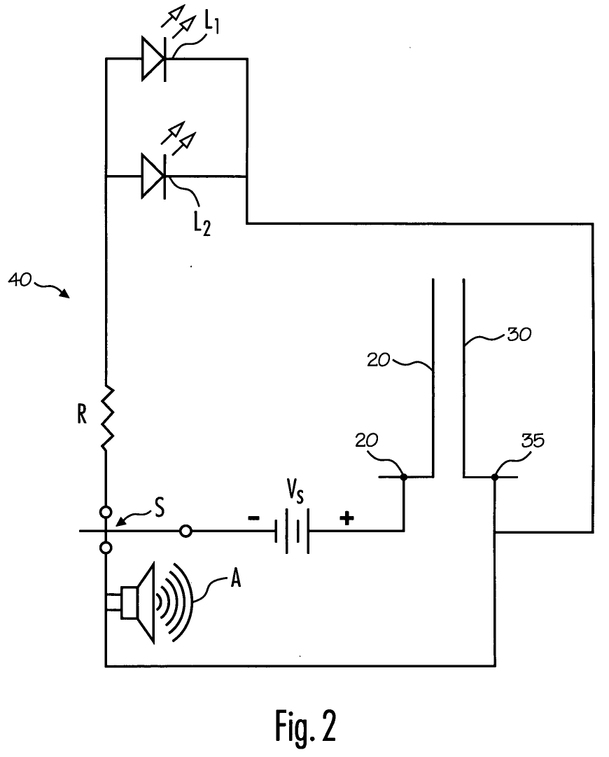

Bracket members 20 and 30, in one embodiment, are formed of electrically conductive material which is in electrical communication with control electronics 40. As seen in FIGS. 1 and 2, the receiving bracket member 20 has a far end portion 21 and a near end portion 23, with the near end portion 23 being securely attached by conductive attachment means (through screws, or nuts and bolts 25, for example, as seen in FIG. 1) to the housing 10. The receiving bracket far end 21 preferably includes a securely coupled retainer 27, the retainer 27 preferably adapted to receive and retain a fishing rod's line end (as apposed to the reel end).

In similar fashion, the contact bracket member 30 has a far end portion 31 and a near end portion 33, with the near end portion 33 being securely attached by conductive attachment means (through screws, or nuts and bolts 35, for example, as seen in FIG. 1) to the housing 10. The contact bracket member far end 31 preferably includes a securely coupled electrical contact means 37. In the embodiment shown in the illustrations, the contact means 35 is disclosed as a screw and nut arrangement, however, those of skill in the art will realize that other contact embodiments may be used according to the present invention (including electrically conductive nubs formed on the contact bracket far end 31). In a preferred embodiment, the distance between the receiving bracket 20 and the contact bracket 30 is a distance D, which is a preselected distance optimized to provide electrical contact between receiving bracket 20 and contact bracket 30 corresponding to a predefined alarm sensitivity level. Thus, in one embodiment, the distance D may be very small (e.g., centimeters apart) reflecting high alarm sensitivity; in contrast, the distance D may be preselectively made further apart (e.g., inches apart) reflecting a much lower alarm sensitivity. In this regard, the disclosed contact means 35 (as being an adjustable screw S and nut arrangement as seen in FIG. 1) may be preferable in most situations because the fisher can easily adjust the alarm sensitivity amount by either moving the screw on the contact bracket away from the receiving bracket (e.g., lowering the alarm sensitivity), or may move the screw on the contact bracket towards the receiving bracket (e.g., increasing the alarm sensitivity). Further, those of skill in the art will recognize that instead of contact bracket member far end 31 having a securely coupled electrical contact means 37 (such as an adjustable screw bored through one of the upright members, for example), this electrical contact means 37 could be placed on receiving bracket far end 21 and achieve the same function as described throughout this disclosure (e.g., electrical contact when compression between the brackets occur through a preselected distance, as illustrated in FIG. 1b). Also, instead of receiving bracket member far end 21 having an attached retainer 27, retainer 27 could be placed on receiving bracket far end 21 and achieve the same function as described throughout this disclosure. Finally, both retainer 27 and contact means 37 could be both placed on either bracket 21 or 31, and still achieve the same function as described throughout this disclosure.

In another embodiment, bracket members 20 and 30 may be formed of non-conductive material (which may be desirable from a cost perspective), yet further include one or more electrically conductive structures (such as conductive wire) placed upon each bracket member, the conductive structures being in electrical communication with the control electronics 40.

Thus, in one embodiment, both receiving bracket 20 and contact bracket 30 may be, in one exemplary representation, a total of 13 inches long and approximately 1.75 inches wide. The longer arms or “uprights” are formed by bending each bracket to an approximately ninety (90) degree angle so that the near end portion 23, 33 are approximately 3 inches long and the remaining bracket portions (the longer arms) are approximately 10 inches long. The brackets may then be mounted to housing 10 parallel to each other at a spacing of no more than ¾ inch apart, with the “L” shaped portion of each bracket directed away from the center of the housing surface. The near end portions 23, 33 may then be permanently attached to the housing 10 with either screws, rivets or like coupling means.

As seen in FIG. 1a, a plurality of electrically conductive screws 25, 35 may couple or attach the members 20, 30 to housing 10, the first electrically conductive screws 25 being in electrical communication with the second electrically conductive screws 35 through control electronics 40.

As seen in FIG. 2, control electronics includes at least one power source Vs (such as a battery source, for example) in electrical communication with multi-throw switch S. In one multi-throw position as selected by the operator, switch S, in turn, may be in electrical communication with either a plurality of light emitting diodes (LEDs L1 and L2 as seen in FIG. 2, or other visual indicator) through conditioning resistor R, so that when bracket 20 contacts bracket 30, a visual light is emitted by the LEDs. In another multi-throw position as selected by the operator, switch S may be in communication with audio speaker A (or other audio indicator), so that when bracket 20 contacts bracket 30 in this switch position, an audible signal is emitted by the speaker. In yet another multi-throw position, switch S may not be in electrical contact with either LED or an audio speaker, in which case the unit will be in the “off” position. Of course, the present invention also contemplates an electronic circuit adapted to provide both an audible and visual alarm system.

In operation according to the preferred embodiment of the present invention, a fisher may cast a fishing line from a fishing rod (or like device) into a nearby lake or stream. However, the fisher may have other tasks to perform (such as tending to other camping matters, or even just sleeping). As such, the present invention incorporates a novel alarm sensor that will assist the fisher in the fisher's goals—namely, to catch fish. Thus, after the fishing line is cast in to the nearby water, the fisher would obtain the present invention, and place the line end (as apposed to the reel end), of a fishing rod into the retainer 27 mounted to the receiving bracket 20 (as illustrated in FIG. 1). The fishing rod should preferably be positioned so that as the fishing line is pulled taunt (as will occur upon a fish bite), the upright portion of receiving bracket 20 can be drawn toward the other upright portion of contact bracket 30 (which is mounted substantially parallel and adjacent to the upright portion of receiving bracket 20). When the fishing line causes both upright bracket portions 21 and 31 to compress towards each other (as may result from a fish bite, as seen for example in FIG. 1b, thereby resulting in the fishing line being pulled taunt), the resulting compression of the vertical upright members 20, 30 (and contact by adjustment screw 37 to the other member) causes an electrical short circuit through control electronics 40, to thereby result in an alarm event. Again, to account for weather and environmental conditions, the adjustment screw 37 is optionally provided to allow for the adjust of the sensitivity of the present invention. For example, if it's breezy, the fisherman may adjust the screw outward to increase the spacing between the screw and the other parallel upright, which will result in fewer false alarms from the wind. On an exceptionally calm day, the fisherman may also adjust the screw inward to almost touching the other upright bracket 21. In this case, the smallest nibble (or, movement of upright bracket 21) will trigger the alarm. As such, in one embodiment, small beeps of sound will be emitted by the audible alarm as the adjustment screw S comes into temporary contact with the other upright member 21. A firm strike will send a constant audible or visible alarm (or both) to let the fisherman know the fish is likely hooked or caught. The adjustment screw 37 further allows for numerous settings to account for almost any type of condition.

While in one preferred embodiment, an audio alarm is used, the alarm may also include a light alarm acting in exactly the same fashion (or, any other similar device which would alert the user that upright member 31 is in contact with upright member 21). There may be occasions when an audible alarm is not appropriate, such as during night fishing.

The present invention may also be adapted for use in other signaling applications. As a security device the unit can be placed by a door, window or any other area suitable connected so that movement will trigger the connection between the contact bracket and the receiving bracket. Further, a microprocessor may be included in the control electronics which is adapted to store security information and transmit such information to a remotely located computer for further processing or security inspection.

While the present invention has been described generally above, the following description provides further detail according to one embodiment of the present invention. While specific units, lengths and compositions are mentioned, such teachings are not meant to limit the scope of the present invention.

Alarm Apparatus—The alarm apparatus preferably consists of two vertical metal L-brackets, one which contains a small L shaped bracket which holds the end of the fishing rod, and contains an adjustment screw to adjust the sensitivity of the alarm signal. The two vertical L-brackets are mounted to a base which is then mounted to the top or lid of the enclosure. The alarm apparatus is detachable and is meant to be stored in the enclosure when not in use. The two vertical L brackets are made out of an electrically conductive metal material (such as steel, for example) that is pliable and can be bent without breaking at a 90 degree angle.

In one embodiment, one of the two vertical L brackets may have a smaller L bracket spot welded or riveted at a point approximately 1 inch from the top of the bracket and centered. This smaller L bracket will measure no more than 1.5 inches long by 0.5 inches wide and will be bent at a 90 degree angle dividing the metal in half. The opposite end of the small L bracket not welded or riveted to the vertical upright will have a 15 to 30 degree bend upward at a point approximately 0.25 inches from the end of the small bracket.

On the same vertical L bracket that the small L bracket is spot welded or riveted to, a threaded hole may be made that will receive the adjustment screw. The hole for the adjustment screw will be made approximately 0.5 inches below the small L bracket and will also be centered on the vertical upright bracket. In one iteration, the hole will be threaded to accept a 1 inch long screw with a large head made for finger tightening to allow for easy fine tune adjustment.

With regard to the base unit, it may preferably be made from conventional plastic or fiberglass material. The base unit is preferably approximately 6.5 inches long and 2 inches wide and 2 inches tall. In one iteration all the electronic equipment that makes up the signaling alarm will be housed within this base unit, therefore, the unit must be sealed and water proof. In another iteration, the signaling alarm will be a separate stand alone unit that mounts separately to the lid of the enclosure. In this iteration the signaling alarm will have two wires with metal clips that will attach to each of the vertical L-Brackets to complete the electrical circuit.

Optionally, the electronic circuit may also include other alarm notification mechanisms, such as the use of one or more wireless protocols or wireless circuits within the control electronics 40 which are adapted to transmit a wireless signal or information to a remotely located operator upon the occurrence of an alarm event. This will be a very attractive feature to those fishermen, for example, who want the fish, but for whatever reason, cannot be located near the water (as may happen when, for example, it is very cold outside and uncomfortable). The popularity of the Internet, wireless technologies and satellite-based technologies has enhanced the way people communicate with each other by allowing users quick and easy access to a virtually endless sea of communication methods. Any user of these technologies may now contact another electronic device with greater or lesser immediacy using various media, including the World Wide Web, electronic mail (email), cellular, satellite or Internet telephony, video conferencing, voice over IP, and instant text messaging. Thus, conceivably, a fisherman may be able, through the present invention, to continue fishing despite being remotely located, all while knowing that the present invention would notify him or his computer of a catch (whether through his mobile phone, pager, his cable television or even by electronic mail over a wireless network such as the Internet). A variety of conventional communications media and protocols may be used for a wireless network as disclosed herein, such as, for example, a connection to an Internet Service Provider (ISP) over a local loop as is typically used in connection with standard modem communication, cable modem, dish network, ISDN, Digital Subscriber Line (DSL), or various wireless communication methods. A representative network may also include a local area network (LAN) which interfaces to a network via a leased line (T1, D3, etc.) and managed by a TCP/IP protocol. Such communication methods are well known in the art, and are covered in a variety of standard texts.

With regard to the alarm system, the signaling alarm preferably consists of an electronic device with both an audio alarm and light signal in one embodiment. This electronic device is connected to the alarm apparatus such that when the L bracket containing the small L shaped bracket which holds the end of the fishing rod moves sufficiently in response to a “bite” from a fish, the adjustment screw makes contact with the parallel vertical L bracket and completes an electrical circuit which triggers the audio or light signal as desired. The components of the signaling alarm are typical of an electronic bicycle alarm. The conventional components are a speaker, light, and the respective electronic circuit boards and wires to connect the light and speaker. The signaling alarm may also be powered by a 9 volt battery, for example. The entire signaling alarm will in one iteration be completely contained and mounted within the base unit.

In still another embodiment, the signaling alarm should be wired such that the electrical circuit required to engage the alarm or light is normally in the open or off position. The vertical L brackets of the Alarm Apparatus each will be connected electrically to the signaling alarm through the base unit. The electrical circuit which triggers either the alarm or light will be closed or turned on when the adjustment screw comes into contact with the second, parallel vertical L bracket. The signaling alarm, whether mounted and housed within the base unit or as a stand alone unit, also includes an operational switch (e.g., an On/Off switch) and a second switch controlling whether completion of the electrical circuit results in an audible signal from the alarm or a visual signal from the light.

With regard to the storage housing, the enclosure is designed to hold multiple objects which the typical fisherman will need. Beginning with the bottom layer of the unit, there may be a channel or void adapted to retain a telescoping fishing rod and reel combination until. The second layer may then contain a void for the alarm apparatus and signaling alarm units. The top layer may hold a tray which is meant to hold common fishing tackle items. The lid of the enclosure has a handle for carrying the unit and a locking mechanism. The lid also has two fasteners which are used to hold the alarm apparatus upright when in use. The enclosure should be made from plastic or fiberglass and must be water tight so that it floats if dropped into the water when in the closed position.

The tackle tray may be a standard tray with provision for typical fishing gear such as hooks, lures, bait, weights etc. The tackle tray will be made of plastic and have a handle so it can easily be removed. Below the tackle tray is a plastic divider which protects the section of the box that houses the Signaling Alarm apparatus. This section has a molded foam cutout that the Signaling Alarm is placed into to avoid damage while being transported. Below the Signaling Alarm section is another plastic divider, once removed the final section reveals the bottom of the enclosure which has enough room between the plastic divider and the base of the unit to accommodate a telescoping fishing rod and reel combination. In one embodiment, the inside dimensions of the enclosure should be no smaller than 17 inches long by 10 inches wide. The depth of the enclosure must be no smaller than 10 inches deep. In another embodiment, the lid of the enclosure will be equipped with a handle located in the exact center of the lid for carrying purposes. Additionally the lid will have a locking mechanism so the unit can be secured in a closed position. Located directly in front of the carrying handle are two latches used to mount the Signaling Alarm to the lid when the unit is in use.

The present invention is superior and preferable to many similar signaling devices in that the unit is separate from the fishing pole. There is nothing to attach or thread the line through or worry about losing into the water along with your pole. Other devices must be staked into the ground. Just set it on the ground, adjust the stability platform depending on terrain or other conditions, and you are ready to go. Still other devices rely on the use of compression of the entire fishing pole. That means you have to have a solid strike to engage the alarm. With the fine adjustment available on the present invention, you can detect nibbles as well as strikes. An experienced fisherman can time a nibble and catch the fish without a solid strike.

The present invention may be embodied as a method, system, kit, an apparatus or a device. Other variations and modifications of the present invention will be apparent to those of ordinary skill in the art, and is not limited except by the appended claims. The particular values and configurations discussed above may be varied, and are cited to illustrate particular embodiments of the present invention. It is contemplated that the use of the present invention can involve components having different characteristics as long as the principles disclosed herein are followed.

1. A sensing alarm comprising a housing adapted to retain and store a control electronics circuit, an indicator placed upon housing, the indicator being in electronic communication with the control electronics circuit, a conductive receiving bracket, and a conductive contact bracket, at least both the receiving bracket and the contact bracket being securely attached to a top portion of the housing, and both the receiving bracket and the contact bracket being in electrical communication with the control electronics, the control electronics circuit adapted to generate an alarm signal when the receiving bracket contacts the contact bracket.

2. The sensing alarm of claim 1 further comprising a mounting plate pivotally attached to a bottom surface of the housing.

3. The sensing alarm of claim 3, the mounting plate being of substantially similar surface area of the housing bottom surface.

4. The sensing alarm of claim 2, the conductive receiving bracket and the contact bracket being securely attached to a top portion of the housing through conductive attachment means, the conductive attachment means being in electrical communication with the electronic control circuit, the receiving bracket and the contact bracket being sufficiently spaced apart a preselected distance corresponding to a predefined alarm sensitivity level.

5. The sensing alarm of claim 4, the receiving bracket further having a near portion and a distal portion, the receiving bracket distal portion having a retainer coupled thereto.

6. The sensing alarm of claim 5, the contact bracket further having a near portion and a distal portion, the contact bracket distal portion having a electrical contact means coupled thereto.

7. The sensing alarm of claim 6 wherein the electrical contact means is an adjustable screw.

8. The sensing alarm of claim 6 wherein the electrical contact means is a conductive nub.

9. The sensing alarm of claim 6, the control electronics circuit further comprising a selectable switch, at least one power source in electrical communication with the switch, at least one visual indicator in electrical communication with the switch, and at least one audible indicator in electrical communication with the switch.

10. The sensing alarm of claim 9, wherein the retainer is adapted to receive a fishing rod's line end.

11. The sensing alarm of claim 9, the control electronics circuit further comprising a microprocessor in electrical communication with the switch, the microprocessor being adapted to transmit information with a remotely located computer.

12. A sensing alarm kit comprising a sensor, the sensor comprising a housing adapted to retain and store a control electronics circuit, an indicator placed upon housing, the indicator being in electronic communication with the control electronics circuit, a conductive receiving bracket, and a conductive contact bracket, at least both the receiving bracket and the contact bracket being securely attached to a top portion of the housing, and both the receiving bracket and the contact bracket being in electrical communication with the control electronics, the control electronics circuit adapted to generate an alarm signal when the receiving bracket contacts the contact bracket, and a tackle box adapted to securely retain the sensor during transportation.

13. The kit of claim 12, the conductive receiving bracket and the contact bracket being securely attached to a top portion of the housing through conductive attachment means, the conductive attachment means being in electrical communication with the electronic control circuit, the receiving bracket and the contact bracket being sufficiently spaced apart a preselected distance corresponding to a predefined alarm sensitivity level.

14. The kit of claim 13, the receiving bracket further having a near portion and a distal portion, the receiving bracket distal portion having a retainer coupled thereto.

15. The kit of claim 14, the contact bracket further having a near portion and a distal portion, the contact bracket distal portion having a electrical contact means coupled thereto.

16. The kit of claim 15, the control electronics circuit further comprising a selectable switch, at least one power source in electrical communication with the switch, at least one visual indicator in electrical communication with the switch, and at least one audible indicator in electrical communication with the switch.

17. The kit of claim 16, wherein the retainer is adapted to receive a fishing rod's line end.

18. The kit of claim 17, the control electronics circuit further comprising a microprocessor in electrical communication with the switch, the microprocessor being adapted to transmit information with a remotely located computer.

19. A sensing alarm comprising a housing adapted to retain and store a control electronics circuit, an indicator placed upon housing, the indicator being in electronic communication with the control electronics circuit, the control electronics circuit further comprising a selectable switch in electrical communication with the indicator, a conductive receiving bracket, and a conductive contact bracket, at least both the receiving bracket and the contact bracket being securely attached to a top portion of the housing, and both the receiving bracket and the contact bracket being in electrical communication with the control electronics, the conductive receiving bracket and the contact bracket being securely attached to a top portion of the housing through conductive attachment means, the conductive attachment means being in electrical communication with the electronic control circuit, the receiving bracket and the contact bracket being sufficiently spaced apart a preselected distance corresponding to a predefined alarm sensitivity level.

20. The sensing alarm of claim 19, the control electronics circuit further comprising a microprocessor in electrical communication with the switch, the microprocessor being adapted to transmit information with a remotely located computer.
